(19) United States
(12) Patent Application Publication
(10) Pub. No.: US 2008/0176175 A1
(43) Pub. Date: Jul. 24, 2008

(54) FLAME REACTION MATERIAL AND A FLAME REACTION MEMBER

(75) Inventor: Da Zheng, Leqing City (CN)

Correspondence Address: MCDERMOTT WILL & EMERY LLP, 18191 VON KARMAN AVE., SUITE 500, IRVINE, CA, 92612-7108, US

(73) Assignee: Ningbo Xinhai Electric Co., Ltd., Cixi City (CN)

(21) Appl. No.: 11/945,957

(22) Filed: Nov. 27, 2007

(30) Foreign Application Priority Data
Jan. 23, 2007 (CN) 200710019624.8

(51) Int. Cl. F23D 14/68; C01D 3/00; F23J 7/00

(52) U.S. Cl. 431/126; 423/312; 423/490; 431/4

(57) ABSTRACT

The present invention relates to a flame reaction material, particularly a gas combustion flame reaction material for gas combustion appliances and a flame reaction member thereof. The gas combustion flame reaction material is formed by a single alkali metal or alkaline earth metal compound, and said alkali metal or alkaline earth metal compound has a melting point lower than combustion temperature of combustible gases and produces a crystal after high-temperature combustion. The flame reaction member comprises a substrate and a flame reaction material adhered to the surface of the substrate in the form of crystal. The substrate is a metal conductor. Because the gas combustion flame reaction material is formed by a single alkali metal or alkaline earth metal compound, the proportion of it to other materials is not required to consider when fabricated and thus it is convenient to produce. Further, the gas combustion flame reaction material may be used to produce a flame reaction member capable of producing a flame with a variety of colors such as yellow, purple, pink, brick red, carmine, kelly and the like.

### FIELD OF THE INVENTION

The present invention relates to a flame reaction material, particularly a flame reaction material for gas combustion appliances and a flame reaction member thereof.

### BACKGROUND OF THE INVENTION

The color of a flame produced by gas combustion appliances such as a torch, a lighter, a lighter for smoker's requisites or the like generally is blue or nacarat, and thus is simplex. In order to color the flame with a variety of vivid colors to make it more watchable and interesting, there is a need to develop a flame reaction material suitable for gas combustion appliances. Many corporations and people are carrying out this study. The flame reaction material should perform a flame reaction under high temperature of the burning gas flame to make the flame have the corresponding color. The principle of flame reaction is described as follows. When heated, peripheral electrons of a metal ion or atom obtain energy and thus the electrons are transition excited from lower energy level orbits to higher energy level orbits. These electrons located in the higher energy level orbits are highly unstable and instantly return to the lower energy level orbits again. In this “returning” process, the electrons release energy, normally in the form of light energy and thus different colors of flame are exhibited. For example, a gas combustion appliance was disclosed in U.S. Pat. No. 5,743,724 (Title: Flame Reaction Member for Gas Combustion Appliances and A Process for Producing the Same; U.S. Pat. No. 5,743,724; Date of patent: Apr. 28, 1998), comprising a fuel storage tank, a combustion cylinder, a nozzle for jetting gas from the fuel storage tank into the combustion cylinder, an igniter for igniting fuel gas jetted into the combustion cylinder, and a flame reaction member comprising a flame reaction material disposed with the combustion cylinder so as to be heated by a gas flame within the combustion cylinder so as to produce a flame reaction which colors the gas flame by the flame reaction, wherein the flame reaction material comprises a glass compound, which is formed by mixing a flame reaction agent and a fused material with each other and fusing them together. Said flame reaction agent comprises a metal compound capable of producing the flame reaction, said fused material is capable of being mixed and fused together with said flame reaction agent and vitrified. This flame reaction material is formed by mixing two, even three or more different materials together. When fabricated, the proportions between them must be well controlled, which is very troublesome. Further, there are no many colors of the flame reaction to be produced.

### SUMMARY OF THE INVENTION

An object of the present invention is to provide a flame reaction material which has a simple component, is easy to prepare and produces more colors of flame reaction.

A further object of the present invention is to provide a flame reaction member formed by using the above flame reaction material.

Therefore, the present invention provides a flame reaction material. The flame reaction material is formed by a single alkali metal or alkaline earth metal compound, and said alkali metal or alkaline earth metal compound has a melting point lower than combustion temperature of combustible gases used in gas combustion appliances and produces a crystal after high-temperature combustion. Further, the flame reaction material is adhered to the surface of a substrate made of a metal conductor in the form of crystal to form a flame reaction member.

Because the flame reaction material is formed by a single alkali metal or alkaline earth metal compound, the proportion of it to other materials is not required to consider when fabricated and thus it is convenient to produce. Further, the flame reaction material may be used to produce a flame reaction member capable of producing a flame with a variety of colors such as yellow, purple, pink, brick red, carmine, kelly and the like.

The present invention will be further explained in combination with embodiments in the following.

### BRIEF DESCRIPTION OF THE DRAWINGS

FIG. 1 is a structurally schematic illustration of an embodiment of a flame reaction member.

FIG. 2 is a structurally schematic illustration of another embodiment of a flame reaction member.

### DETAILED DESCRIPTION OF THE INVENTION

The flame reaction material is formed by a single alkali metal or alkaline earth metal compound, and said alkali metal or alkaline earth metal compound has a melting point lower than combustion temperature of combustible gases used in gas combustion appliances and produces a crystal after high-temperature combustion. Generally, the combustion temperature of combustible gases is greater than 1300° C., therefore the melting point of the alkali metal or alkaline earth metal compound lower than 1300° C. may be suitable. The alkali metal compound may be selected from the group consisting of sodium sulfate (Na₂SO₄), sodium silicate, or other salts of sodium, potassium sulfate (K₂SO₄), potassium chloride (KCl), or rubidium chloride (RbCl). Sodium sulfate (Na₂SO₄), sodium silicate, or other salts of sodium may produce a yellow flame reaction. Potassium sulfate (K₂SO₄) may produce a purple flame reaction. Potassium chloride (KCl) may produce a pink flame reaction. Rubidium chloride (RbCl) may produce a purple flame reaction. The alkaline earth metal compound is selected from the group consisting of calcium chloride (CaCl₂), strontium chloride (SrCl₂), or barium metaborate (Ba(BO₂)₂). Calcium chloride (CaCl₂) may produce a brick red flame reaction. Strontium chloride (SrCl₂) may produce a carmine flame reaction. Barium metaborate (Ba(BO₂)₂) may produce a kelly flame reaction.

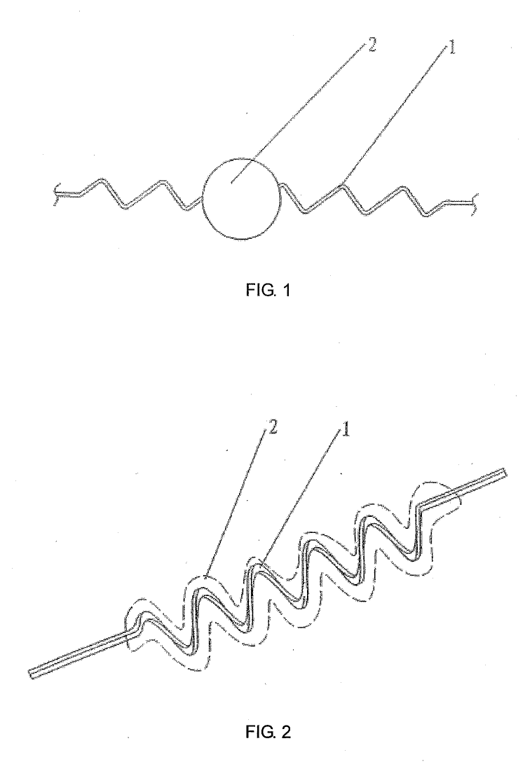

The flame reaction member comprises a substrate 1 and a flame reaction material 2 adhered to the surface of the substrate 1 in the form of crystal. The substrate 1 is a metal conductor (for example, nickel-chromium, stainless steel, etc.), formed as a wire (as showed in FIG. 1) or a flat belt and then wound as a helix (as showed in FIG. 1) or a ripple form. A voltage is applied onto two ends of the substrate 1; the flame reaction material 2 is contacted with the metal conductor substrate 1 and melted under high temperature produced by the heat of the metal conductor resistor; after converting from solid into liquid, the flame reaction material is adhered to the surface of the substrate 1; the voltage applied onto the substrate 1 is then removed; after the temperature dropping, the flame reaction material 2 converts from liquid back into solid and is adhered to the surface of the substrate 1 made of the metal conductor in the form of crystal to form the flame reaction member.

What is claimed is:

1. A flame reaction material characterized in that the flame reaction material is formed by a single alkali metal or alkaline earth metal compound, and said alkali metal or alkaline earth metal compound has a melting point lower than combustion temperature of combustible gases and produces a crystal after high-temperature combustion.

2. The flame reaction material of claim 1, characterized in that the alkali metal compound is selected from sodium sulfate, sodium silicate or other salts of sodium.

3. The flame reaction material of claim 1, characterized in that the alkali metal compound is potassium sulfate.

4. The flame reaction material of claim 1, characterized in that the alkali metal compound is potassium chloride.

5. The flame reaction material of claim 1, characterized in that the alkali metal compound is rubidium chloride.

6. The flame reaction material of claim 1, characterized in that the alkaline earth metal compound is calcium chloride.

7. The flame reaction material of claim 1, characterized in that the alkaline earth metal compound is strontium chloride.

8. The flame reaction material of claim 1, characterized in that the alkaline earth metal compound is barium metaborate.

9. Aflame reaction member produced from the flame reaction material of any one of claims 1-8, characterized in that the flame reaction member comprises a substrate and a flame reaction material adhered to the surface of the substrate in the form of crystal, and the substrate is a metal conductor.
